(19) United States
(12) Patent Application Publication
(10) Pub. No.: US 2007/0162350 A1
(43) Pub. Date: Jul. 12, 2007

(54) Method and apparatus for retrieving remote data based on local indicia

(76) Inventor: Paul R. Friedman, Los Angeles, CA (US)

Correspondence Address: CHRISTIE, PARKER & HALE, LLP, PO BOX 7068, PASADENA, CA, 91109-7068, US

(21) Appl. No.: 11/604,058

(22) Filed: Nov. 22, 2006

Related U.S. Application Data
(60) Provisional application No. 60/739,230, filed on Nov. 23, 2005.

(51) Int. Cl. G06Q 99/00

(52) U.S. Cl. 705/26; 705/1; 705/14

(57) ABSTRACT

A method and apparatus for scanning an indicium local to a user on an advertisement or product. The scanning may be carried out by using a user device, such as a cellular phone or personal digital assistant (PDA), as an input device. The indicium may include an alphanumeric code encoded or embedded therein. The alphanumeric code may be sent over a communication network such as the Internet to a lookup server. The lookup server will correlate the alphanumeric code with a location identifier. The location identifier may be a universal resource locator (URL) indicating a specific webpage containing information and/or interactive tools related to the item bearing the indicium.

### CROSS-REFERENCE TO RELATED APPLICATION

This application claims priority to and the benefit of U.S. Provisional Patent Application No. 60/739,230 entitled “Method and Apparatus for Retrieving Remote Data Based on Local Indicia,” filed Nov. 23, 2005, the entire content of which is incorporated by reference herein.

### BACKGROUND

1. Technical Field

The invention relates to a method and apparatus for data retrieval. Specifically, the embodiments of the invention relate to retrieving remote data based on local indicia.

2. Description of Related Art

Bar codes, radio frequency identification (RFID) tags and similar technologies are in common use in many industries. These identification technologies have been used to manage inventories, track products, identify files and manage the transport of items. The technology has been applied to the retail, shipping, health care, legal and manufacturing fields. There are different encoding systems in use including Code 39, Code 128, PDF417, Postnet and similar systems for encoding information into bar codes and RFID tags. These bar codes and RFID tags are read by fixed, handheld and wireless devices using infrared or laser scanning technology and radio frequency (RF) receivers to capture the encodings in the tags. Generally, RFID tags provide the same functionality as bar codes. However, the identification information encoded in the RFID tags can be obtained by bringing a receiver device into proximity with the tag and does not require a direct line of sight like a laser scanner.

Most consumers are familiar with universal product code (UPC) codes that are placed on packaging of retail and food products. These bar codes are scanned by a laser scanner, such as a fixed or handheld scanner to retrieve an encoded 12 digit number. This encoded number is used to lookup product information in a database in communication with the scanning device or attached to a computing device such as a desktop computer, register, handheld computer or laptop computer. This product information may be retrieved or updated depending on the context in which a scan takes place or the machine that is performing the scan. Similar systems using different encoding systems are used in shipping and warehouse facilities to manage a database of containers, boxes and packages including content information, location, quantity, shipping information and similar information.

Inventory and file management systems use bar codes and RFID tags to track file inventory and file locations. In these systems, a database is maintained with file and item identification numbers that are associated with each file or item. Records for each file or item may be stored in a database and include price, quantity, location or similar information related to the file or item. Information may be updated by a user or based on contextual information provided by a user or scanning device.

PDF417 bar codes provide encoding for up to 1.1 kilobytes of information and are often used to encode information related to personal identification or security. PDF417 is a two dimensional bar code that may be used to store personal information and even photographs, fingerprints and similar security relevant data. These bar codes are often affixed to identification cards such as driver's licenses.

Postnet is a bar code system used to encode address information for a piece of mail, specifically zip code information. Labels with Postnet codes are affixed or printed onto mail pieces to facilitate the delivery of mail by providing a machine readable address that sorting machines can recognize.

Scanning devices are typically dedicated to the function of scanning and may provide additional functionality related to specific tasks related to the bar code or RFID tag system. For example, handheld scanning devices are used in grocery stores, to scan inventory and input pricing and quantity information related to the scanned item into the database system. Scanning devices are also used at event venues such as stadiums to scan tickets and update a central database tracking ticket use. Fixed scanners are also used in similar locales. Fixed scanners are frequently used in grocery stores and tied to cash registers to scan groceries during a checkout procedure. Fixed scanners are sometimes used at airport terminals to scan airline tickets as passengers board planes or to scan passports during the customs process.

U.S. Pat. No. 6,076,733 issued to Wilz, Sr. et al., discloses a web-based system and method for enabling a viewer to access and display HTML-encoded documents located on the World Wide Web (WWW) by reading universal resource locator (URL)-encoded bar code symbols printed on a web-based information resource guide. While this patent discloses using a bar code scanner to obtain web page addresses, it discloses that the URL itself is encoded in the bar code.

### SUMMARY OF THE INVENTION

In an exemplary embodiment according to the present invention, a system includes an input device including an indicium input mechanism adapted to receive indicium data of an indicium and to send an indicium lookup request over a communication network; and a server adapted to be in electronic communication with the input device over the communication network, wherein the server is adapted to process the indicium lookup request and to return a location identifier for information corresponding to the indicium to the input device.

In another exemplary embodiment according to the present invention, a method of accessing information corresponding to an indicium, is provided. The method includes: reading the indicium using an input device to obtain indicium data; generating a lookup request using the indicium data; sending the lookup request to a server; receiving a location identifier for information corresponding to the indicium, from the server; accessing the information corresponding to the indicium, using the location identifier; and displaying the accessed information on the input device.

In another exemplary embodiment according to the present invention, an indicium reading device is provided. The indicium reading device includes: a scanning device adapted to input indicium data corresponding to an indicium; a display device adapted to display information retrieved from a location associated with the indicium; a communications device adapted to request the information using the indicium data; and a processor adapted to execute a local application to generate a request to a server using the indicium data and to retrieve the information from the location associated with the indicium, for display on the display device.

### BRIEF DESCRIPTION OF THE DRAWINGS

Embodiments of the invention are illustrated by way of example and not by way of limitation in the figures of the accompanying drawings in which like references indicate like elements. It should be noted that references to “an” “one” embodiment in this discussion are not necessarily to the same embodiment, and such references mean at least one.

FIG. 1 is a diagram of one embodiment of an indicium input and data retrieval system.

FIG. 1A is a schematic view of a webpage of the system website of an indicium input and data retrieval system.

FIG. 2 is a diagram of one embodiment of a process of retrieving data associated with an indicium marked object.

FIG. 3 is a diagram of one embodiment of a process or looking up data related to an indicium marked object.

FIG. 4A is a screen shot of one embodiment of a webpage retrieved in response to the input of an indicium.

FIG. 4B is a screen shot of one embodiment of a webpage retrieved in response to the input of an indicium.

In accordance with common practice, the various features illustrated in the drawings may not be drawn to scale. Accordingly, the dimensions of the various features may have been arbitrarily expanded or reduced for clarity. In addition, some of the drawings may be simplified for clarity. Thus, the drawings may not depict all of the components of a given apparatus or method. Also, like reference numerals denote like features throughout the specification and figures.

### DETAILED DESCRIPTION

A system of placing indicia onto products, advertisements and other objects to allow convenient retrieval of information related to the objects, is provided in embodiments according to the present invention. In one embodiment, an indicium on the object is read or scanned to input indicium data embedded or encoded in the indicium, into a user device local (or in proximity) to the object. In other embodiments, voice recognition or activation programs may be used to input indicium data into the user device. The user device communicates with a remote server housing a lookup database that is used to convert the encoding of the indicium (i.e., indicium data) into information related to the object. A camera and/or any other suitable optical input device may also be used by the user to input or enter indicium data or any other relevant information into the device. The user may also be able to manually enter the indicium data using a keyboard, keypad, or any other suitable input mechanism.

In one embodiment, the information retrieved during the lookup process may be an Internet address or universal resource locator (URL). The client application or plug-in located on the local user device (i.e., an input device) may use the returned information, such as a URL, to access a website or webpages containing additional information related to the object with the indicium. The website or webpages may provide purchasing information, product information, multimedia information or similar data tied to the product. This website or webpage information is returned to the user device to be displayed or played back to the user via a display and/or speakers coupled to the user device. The user may interact with the website or webpages related to the scanned object instantaneously and easily where the accessing of the related website or webpages is achieved in a manner transparent to the user. The scan and lookup process may result in an automated operation such as an automatic purchase of a product or playing of a multimedia file. Many different types of user devices may be used to scan and interact with the system including personal digital assistants (PDAs), cellular phones, laptops and similar devices.

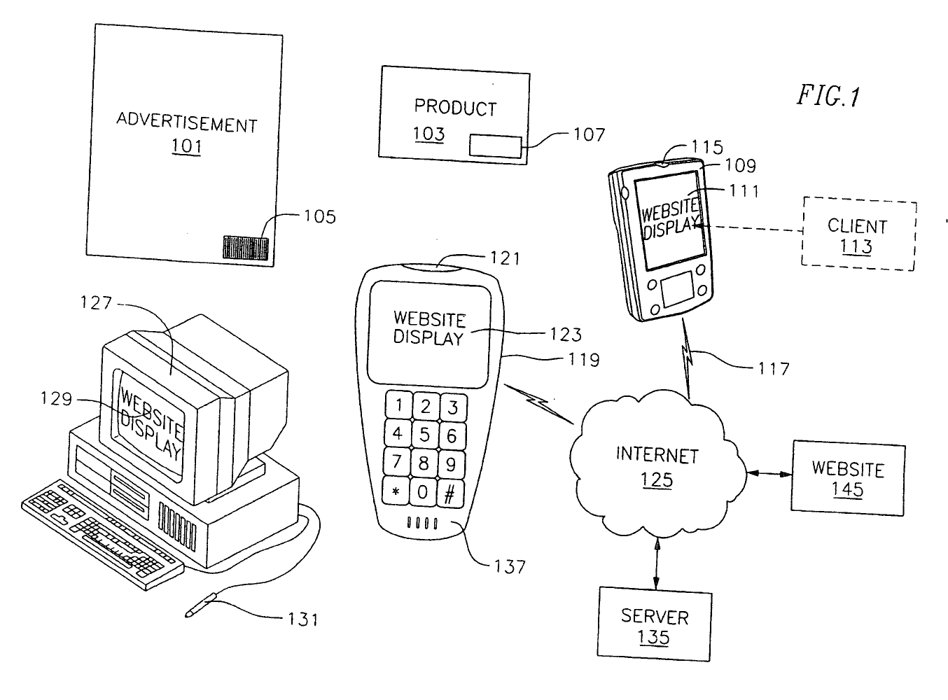

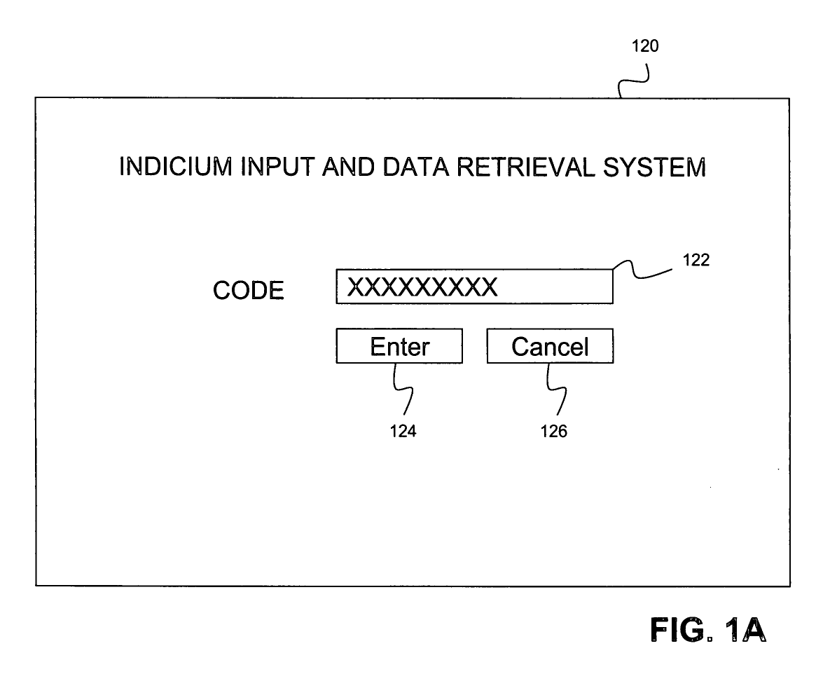

FIG. 1 is a diagram of one embodiment of a system for retrieving data related to an object with an associated indicium. In one embodiment, an object may be any item encountered in daily life. For example, an object may be an advertisement 101. The advertisement 101 may be in the form of a poster, flyer, page in a magazine or book or similar type of advertisement. The advertisement may contain an indicium 105, such as, for example, a one or two-dimensional bar code. Other types of objects that the system may be used with include retail products 103, files, art, signs, packaging, displays and similar objects. In another example embodiment, music compact disc (CD) packaging 103 or similar packaging or product may have an RFID tag 107 attached, which may also be referred to as an indicium in one embodiment.

The indicium 105 or the RFID tag 107 may be specifically generated for the indicium input and data retrieval system of the embodiments according to the present invention, or it may be a standard indicium (such as a standard one or two dimensional bar code) commonly used by those skilled in the art. By way of example, the indicium 105 may include a standard bar code printed on consumer goods such as boxes, cans, product labels, etc. Similarly, the RFID tag 107 may include a standard RFID tag commonly used in the music industry on CD packaging, in the movie industry on DVD or other video packaging, and/or the like. multimedia information or similar data tied to the product. This website or webpage information is returned to the user device to be displayed or played back to the user via a display and/or speakers coupled to the user device. The user may interact with the website or webpages related to the scanned object instantaneously and easily where the accessing of the related website or webpages is achieved in a manner transparent to the user. The scan and lookup process may result in an automated operation such as an automatic purchase of a product or playing of a multimedia file. Many different types of user devices may be used to scan and interact with the system including personal digital assistants (PDAs), cellular phones, laptops and similar devices.

FIG. 1 is a diagram of one embodiment of a system for retrieving data related to an object with an associated indicium. In one embodiment, an object may be any item encountered in daily life. For example, an object may be an advertisement 101. The advertisement 101 may be in the form of a poster, flyer, page in a magazine or book or similar type of advertisement. The advertisement may contain an indicium 105, such as, for example, a one or two-dimensional bar code. Other types of objects that the system may be used with include retail products 103, files, art, signs, packaging, displays and similar objects. In another example embodiment, music compact disc (CD) packaging 103 or similar packaging or product may have an RFID tag 107 attached, which may also be referred to as an indicium in one embodiment.

The indicium 105 or the RFID tag 107 may be specifically generated for the indicium input and data retrieval system of the embodiments according to the present invention, or it may be a standard indicium (such as a standard one or two dimensional bar code) commonly used by those skilled in the art. By way of example, the indicium 105 may include a standard bar code printed on consumer goods such as boxes, cans, product labels, etc. Similarly, the RFID tag 107 may include a standard RFID tag commonly used in the music industry on CD packaging, in the movie industry on DVD or other video packaging, and/or the like.

Such standard indicium, RFID tag or other identifier can be used by the indicium input and data retrieval system to provide additional information in embodiments according to the present invention. By way of example, the consumer may enter the standard bar code on a canned good into the indicium input and data retrieval system. The indicium input and data retrieval system may provide additional information such as nutritional information, recipes, reviews, links to other related products, and/or the like to the consumer. To this end, a special webpage may be created with the product information on a server 135 shown in FIG. 1. Such special webpage, for example, may contain the product information and/or other related information for the product bearing the bar code. Hence, in one embodiment, the server 135 can be programmed to interpret any bar code from any product or source, such as, for example, a can of soup being sold at a supermarket, to provide additional related information.

In one embodiment, the indicium 105 may be any type of identification tag capable of being accessed through machine reading or providing encoded information including a bar code, radio frequency identification (RFID) tag or similar tag system. Bar codes may employ any standard encoding system or customized encoding systems. Bar codes can be printed onto or attached as a label to any type of item. RFID tags 107 may be affixed to packaging or other items through an adhesive or similar attachment mechanism or may be manufactured to be integral with an item or packaging.

In one embodiment, a user may access information related to objects bearing an indicium through a user device (also referred to as a user input device or an input device). A user device may be a personal information manager (PIM), personal digital assistant (PDA) 109, a cellular phone 119, a personal computer 127, laptop or similar device. Any device capable of interfacing with a scanner, receiver, video input, audio input or similar tag identification mechanism and capable of displaying or playing back information to a user directly or indirectly may be used. In one example embodiment, a PDA 109 or cellular phone 119 may be used to access information associated with an advertisement 101. The PDA 109 or cellular phone 119 may include a scanning mechanism 115, 121 such as a laser scanning device, infrared scanning device, RF receiver or similar technology. The scanning mechanism 115, 121 may interface with a client application 113 to receive or decode information from the indicium. The user device may include a processor to execute the client application 113. While the scanning mechanism 115 and 121 are shown as integrated to the respective device in FIG. 1, in one or more embodiments of the present invention, the scanning mechanism may be provided as an external scanning device (e.g., laser or infrared scanner, or RFID scanner) coupled to the PDA 109 or the cellular phone 119.

In another embodiment, any device capable of voice activation or recognition may be utilized to input indicium information. The indicium information may be read or recited by a user to the device which receives the information through an audio input 137, such as a microphone. The voice recognition or activation functionality may be provided by any user device including a PIM, a PDA 109, a cellular phone 119, a personal computer 127, laptop or similar device. Any device capable of receiving and processing audio information from a microphone or similar input and capable of displaying or playing back information to a user directly or indirectly may be used. in one example embodiment, a PDA 109 or cellular phone 119 may be used to access information associated with an advertisement 101. The user may read the indicium, for example a code number or universal resource locator (URL) into the PDA 109 or cellular phone 119 or similar device via a microphone or similar audio input device 137. The voice recognition and activation process may interface with a client application 113 to receive or decode the audio input to determine the code or information related to the indicium.

In other embodiments, the PIM, the PDA 109 and/or the cellular phone 121 may include an integrated camera that can be used to photograph the indicia (e.g., indicium 105). The photographs of the indicia then can be used to determine the code or information embedded in the indicium through image processing and/or using pattern recognition software running in the client application and/or the server. In other embodiments, the PDA 109, the cellular phone 121 and/or the personal computer 127 may be coupled to an external camera for taking such photographs of indicia. Such integrated or external camera may be available instead of or in addition to the scanning mechanism and/or the voice recognition mechanism for data entry. For the photograph to be decoded or interpreted by the server, in one embodiment, the user device (e.g., the PIM, the PDA 109, the cellular phone 121 or the personal computer 127) sends the photograph to the server 135. In still other embodiments, any other suitable optical device may be used for the optical detection of indicia.

In one embodiment, the indicium information may be an identifying number, alphanumeric code, object description or similar information. The indicium may use any type of encoding system including standardized systems such as universal product codes (UPCs), code 39, code 128, PDF417, customized or specialized indicia or similar systems. The identification information retrieved from an indicium may be an alphanumeric identifier or similar identifying code. The code may be unique to the object or to a class of objects. In another embodiment, location information may be embedded in the indicium. For example, the indicium may encode a universal resource locator (URL) or similar information in other embodiments.

In one embodiment, the user device may include a client application 113. The client application 113 may be a separate application or a plug-in or component of another application such as a browser. The client application 113 may be provided as part of the user device, be downloaded over a network onto the device, installed from another medium or similarly transferred and installed onto the user device. In one embodiment, the client application 113 may be an option provided by a service provider such as a cellular phone company or Internet service provider. Different versions of the software may exist that are compatible with different platforms such as Windows® by Microsoft® Corporation of Seattle, Wash., OS X by Apple® Computer of Cupertino, Calif., cellular phone operating systems, Java® by Sun Microsystems® of Santa Clara, Calif., Internet Explorer® (by Microsoft® Corporation) plug-in, handheld OS's, console device OS's and similar platforms and operating environments.

The client application 113 interfaces with the drivers or software for an input device such as a laser or infrared scanner, RF receiver or audio input device for obtaining the object identifier data. In one embodiment, the client application 113 manages communication with a remote server 135 to obtain location information. By way of example, in one embodiment, a specific URL can be embedded in a web page of the server 135, such that the URL can be retrieved by the client application. The client application 113 may communicate with the server 135 through a wireless link 117 or wired link to the Internet 125 or similar network. The wireless connection may be a Bluetooth, 802.11, cellular or similar connection with a node such as a wireless access point connected to the Internet. In another embodiment, a private network, wide area network, standard phone network or any other suitable telecommunications network may be the medium for connecting the user device with the server.

In one embodiment, the server 135 provides location information, such as a URL, to the client application 113 in response to a request from the client application 113 including information from the indicium. Referring to FIG. 1A, the request can be made using an interactive webpage (of a website) 120 available from the server 135. By way of example, the PDA 109, the cellular phone 119 or the personal computer 127 may display the interactive web page 120 on its respective local display (or website display area) 111, 123 or 129. Data or information can be entered in the interactive web page of the server 135 using a scanner, a camera and image processing, voice recognition software and/or manual entry (e.g., in a code input field 122) using a keyboard, a keypad and/or any other suitable input device (e.g., thumb wheel) known to those skilled in the art. The code can be entered through pressing an ‘Enter’ button 124 or a ‘Cancel’ button 126. The code or information entered through non-manual methods such as scanning or photography may be automatically processed without requiring the user to press the ‘Enter’ button 124 or the ‘Cancel’ button 126. Hence, the website of the server 135 can be used as a portal for entering the code encoded in the indicium, such that the code can be used by the server 135 to return the location information to the client application 113.

Returning now to FIG. 1, the client application 113 then accesses the location received from the server 135 and displays the information at that location to the user via a local display 111. The location may be a website, a set of webpages on a website, a media file or similar information. As such, in one embodiment, the server 135 provides the location information to the client application 113 rather than encoding the location information (e.g., URL) into an indicium such as a bar code. This way, this embodiment is better adapted to monitoring or tracking traffic or usage than the system in which URL is encoded in the bar code itself, because the user using this embodiment uses the client application 113 to access the server 135 in order to obtain the location information of the desired web site, webpages on a website or any other suitable information (e.g., media file such as multi-media file).

The client application 113 may interface with a browser, media player or other application to display or play back the data retrieved from the location. The service provider, user device manufacturer or similar entity may customize the display generated by the client application to include a corporate logo, additional information or functionality or similar specialized modification. The display of retrieved information related to the item with the indicium may also be joined with information, tools, graphics, media, webpages or similar information from the retrieval management company administering the lookup server. For example, the management company may have its own website providing search functionality. A frame of a browser display may contain a webpage from the management company providing a manual entry search or similar function, while the other frames of the browser display the retrieved location information.

In one embodiment, the server 135 may retrieve some or all of the information at a target location to be forwarded to a user. In another embodiment, the client application 113 uses location information retrieved from the indicium to connect directly with a website, webpage or similar location with information related to the target.

In one embodiment, a user device may temporarily be offline due to a lack of connectivity with a network, an unplugged cable or similar issue. The input indicium or information retrieved from the indicium may be stored in the user device. When the user device regains connectivity the user may select the stored indicium or information to initiate the lookup and retrieval process. In another embodiment, the user may be able to store indicium or indicium related information in the user device even when connected to the network for future reference or use.

Other example user devices may include a cellular phone 119 and/or a personal computer 127. A cellular phone 119 may include a display 123 for presenting data retrieved from the location provided by the server 135, an input device such as a scanner 121 or microphone 137 to obtain indicium information, a wireless communication transceiver and similar components. A personal computer 127 includes a monitor for displaying information retrieved from the location provided by the server 135, a peripheral input device, such as an infrared or laser scanner 131, RF receiver or similar indicium reading device or a microphone or similar audio input device for receiving audio input for the indicium to be processed by a voice recognition or activation system, a communication link with the Internet or similar network providing connectivity with the server 135 and the location provided by the server, such as a website 145.

FIG. 2 is a flowchart of one embodiment of a process for processing data obtained from an indicium by a user device (also referred to as an input device or a user input device herein) that has the client application installed. In one embodiment, the process may be initiated by a user activating an indicium scanning or reading device such as a laser scanner or RF receiver (block 201). In one embodiment, prior to scanning or reading the indicium (e.g., one or two dimensional bar code, or RFID tag), the user device already displays a webpage from the server. In such instance, the webpage is used as the portal through which the indicium data, i.e., information embedded or encoded in the indicium, is provided to the server. Of course, the webpage may be displayed using a standard or custom web browser (e.g., Internet Explorer® or Netscape® Navigator). In other embodiments, the indicium data or other necessary information for looking up the server database, may be entered into the user device using a microphone and voice recognition software and/or manual entry, in addition to or instead of the scanning or reading of the indicium.

Scanning software in the user device interprets the indicium data or information received from the indicium into an identifying alphanumeric code or similar identifying information. The client application receives this information and generates a lookup request to be sent to a remote server (block 203). The request may be sent over a wireless communication link and the Internet or through any suitable communications medium and suitable protocol including TCP-IP. In one embodiment, when the webpage of the server is already being displayed in the user device, the server webpage can be used as an interactive webpage or portal through which the indicium data, the lookup request and/or any other information is sent to the server. In this instance, the web browser may be used to send the lookup request to the server.

The server executes a lookup for the information sent in the request and provides a response message to the client application (block 205). The response message may include location information such as a URL or similar indicator for locating information related to the object associated with the indicium. The client application and/or the web browser may then access the location provided by the server and retrieve information stored there (block 207). The location may be a website where webpages are provided by a web server, the location may contain a media file to be downloaded and played back by a media player, the location may provide a mixture of multimedia information, or similar data. For example, an indicium scanned from a package of a compact disc may be linked to a webpage where music from the album may be sampled, band profiles and information viewed and concert tickets, albums, individual tracks and band souvenirs and paraphernalia may be purchased. Further, an indicium scanned from a movie or other multi-media packaging may be linked to a webpage where streaming video may be sampled, for example. Such a referenced webpage may be deep within a site. Using the indicium input system a user can quickly access a relevant page without having to navigate through the site starting at a homepage.

In another embodiment, the server may retrieve some or all of the information at the target location identified by the lookup results. This information may then be forwarded onto the user device to be displayed to the user. In a further embodiment, the indicium may contain location information that can be directly accessed over the network by the user device without the assistance of a lookup server.

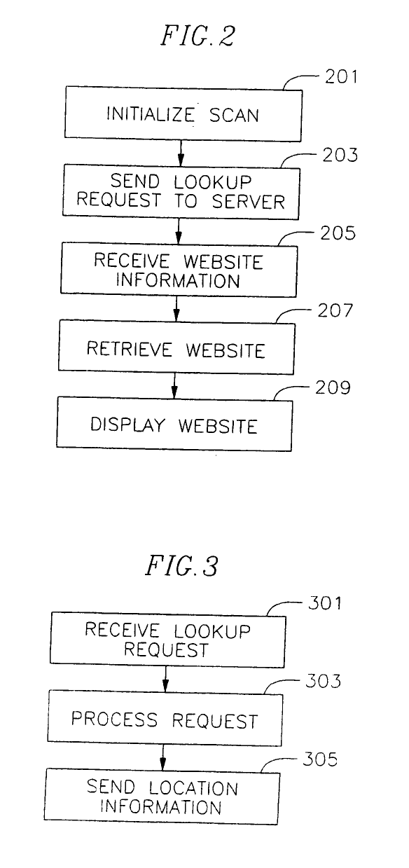

FIG. 3 is a flowchart of one embodiment of a server process for handling requests from user device. In one embodiment, the server may receive a message from a client application that contains an alphanumeric code or similar information obtained from an indicium of an object (block 301). The server may process this request by generating a query or similar lookup operation using the alphanumeric code as a search term or key (block 303). The query or search may be executed through a database management system or similar data management system. The results of the search may be formatted into a message to be sent back to the client application (block 305). The search results may return location information such as a URL or similar information. If the search is unsuccessful an error code message may be returned to the client application.

This system can be applied and adapted for numerous industries and applications. Primarily, these embodiments of the system allow a user of a general purpose device such as a PDA or cellular phone to gain instant access to interactive content from the web related to an object they encounter in everyday life. Embodiments include applications of the system where bar codes or identification tags are provided on advertisements for products and the web-based information provided via the user device allows for immediate arrangement of a purchase of the product to be shipped to the user. A similar adaptation may be used in store to order an item for pickup at the checkout counter, including options for gift wrap, coordination with a gift registry and similar services. Other embodiments provide media content to a user as part of a marketing campaign or similar effort to inform a user of services and products. A user may scan a movie poster to obtain a trailer, streaming video, moving photographic images, or soundtrack information, determine theater location and start times, purchase tickets, listen to sample tracks from a CD. Indicia on a CD may provide sample tracks. Indicia on a book may provide special material such as comments from an author, a sample chapter or a list of similar books the user might like to purchase. Further, indicia on other suitable objects may be used to order checks and/or to access personal banking information.

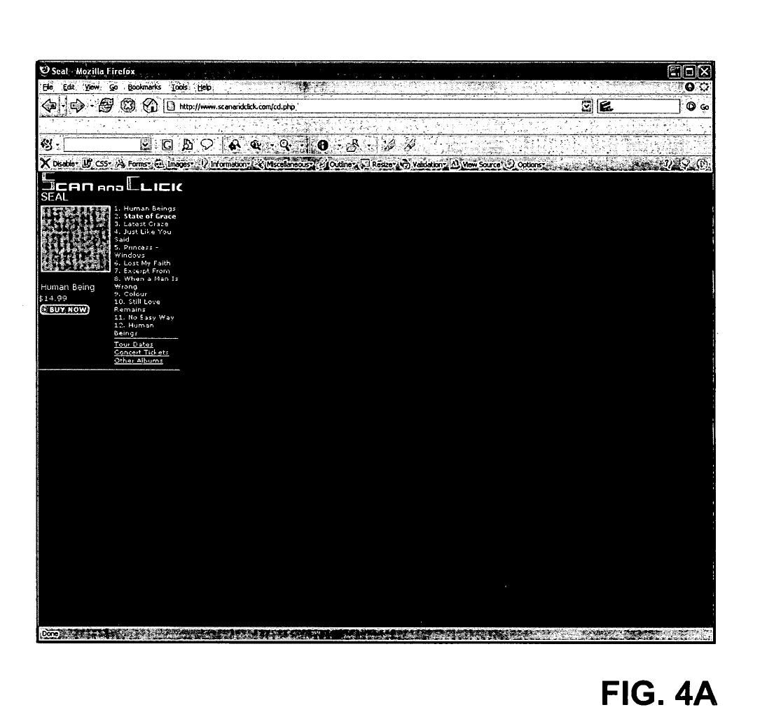

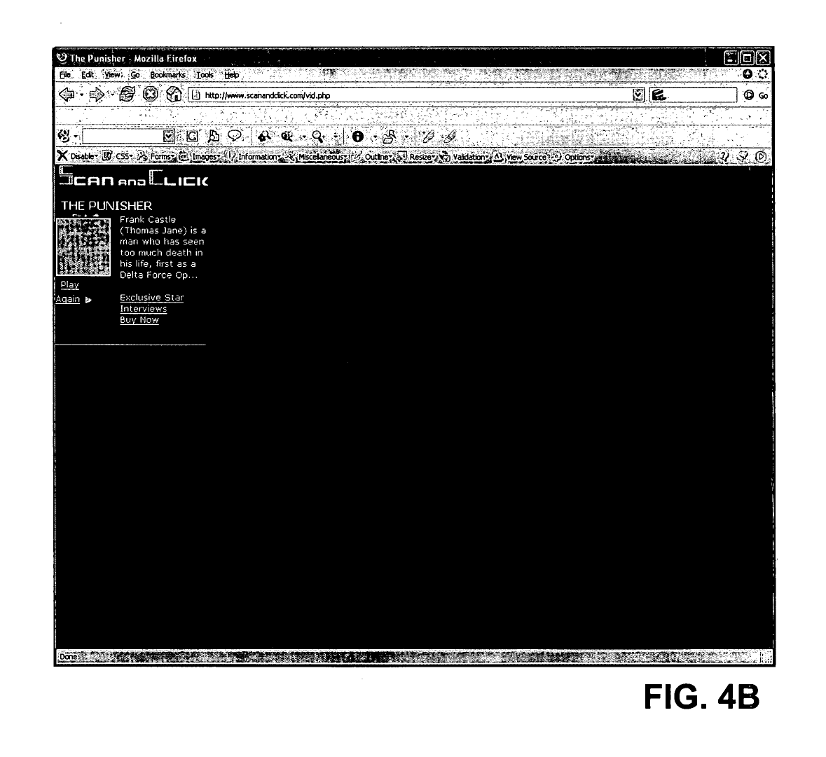

FIG. 4A is a diagram of one embodiment of a webpage associated with an indicium on a CD. The website contains information about the artist, tracks on the CD, links to tour dates for the artist, concert tickets, information on other albums by the artist and an option to purchase the CD. Links for each of the tracks of the album may used to listen to a sample of the track or to hear the complete track. FIG. 4B is a diagram of one embodiment of a webpage associated with an indicium from a movie poster. The website present information about the movie including a short synopsis of the movie and links to multimedia content including a trailer for the movie and star interviews. A link may also be presented for purchasing the movie on digital versatile disc (DVD), universal media disc (UMD) or other suitable medium.

Other example embodiments include use of the system to purchase tickets for concerts or sporting events from bar codes in newspapers, flyers or similar media. The same types of bar code advertisements may provide information about upcoming games, concerts and similar events. Other embodiments include the use of bar codes on flyers or advertisements for services that result in the scheduling of an appointment to use the service based on a scan of the code. For example, a beauty salon, dentist or similar service provider may allow for automated scheduling using the system. A store or manufacturer may use the codes in their advertisements to provide coupons to be redeemed for their products. The coded tags may also be used to provide telephone numbers to the user, especially for cellular phone users. The phone number obtained from the scan can be stored in the phone or start an automatic call to the number.

In one embodiment, an additional advantage of this system is the collection of user preferences, personal habits, purchases and similar information based on the user interaction with the system. Each time a user scans an item and requests information related to the item from the server, a log may be kept specific to that user to collect the information by noting the time, place and item scanned as well as other contextual information that may be available. This information may be used to enhance or specialize services for that customer by recommending similar products, events or services. The information may also be provided to the website provider, intermediate service providers and other related entities to allow them to tailor their services and marketing for the user.

In view of the above, it should be understood that an indicium lookup and data retrieval system may be constructed using various combinations and modifications of the structures, components and processes described herein. For example, the structure, components and processes described in a given drawing may be used in a component or process described in another drawing.

In addition, the components described herein may be implemented in a variety of ways. For example, the client application described herein may be software executed by the user device, firmware and/or an application specific integrated circuit (ASIC). Also, the combinations of some of the components which are described herein as being “attached,” “connected” “including,” “affixed,” etc., may be implemented as one or more integral components.

It should be appreciated that the applications discussed herein regarding various embodiments may be applicable to other uses and contexts as well. For example, the lookup and retrieval process described above may be utilized in telephone number and address lookup. Different embodiments of the user devices described above may include a variety of hardware and software processing components.

In some embodiments, code such as software or firmware executing on one or more processing devices may be used to implement one or more of the described operations. The signals between sensors and external devices may take several forms. For example, in some embodiments a signal may be an electrical signal transmitted over a wire while other signals may include of wireless signals transmitted through space. In addition, a group of signals may be collectively referred to as a signal herein. The signals discussed above also may take the form of data. For example, in some embodiments a client application of a user device may send a signal to another computer, a server, a wireless access node or similar equipment. Such a signal may be stored in a data memory at any point.

The embodiments of the invention described herein may be used as part of a data retrieval system. While certain exemplary embodiments have been described above in detail and shown in the accompanying drawings, it is to be understood that such embodiments are merely illustrative of and not restrictive of the broad invention. In particular, it should be recognized that the teachings of the invention apply to a wide variety of systems and processes. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims and equivalents thereof.

What is claimed is:

1. A system comprising:
an input device comprising an indicium input mechanism adapted to receive indicium data of an indicium and to send an indicium lookup request over a communication network; and
a server adapted to be in electronic communication with the input device over the communication network, wherein the server is adapted to process the indicium lookup request and to return a location identifier for information corresponding to the indicium to the input device.

2. The system of claim 1, wherein the input device comprises a personal data assistant (PDA), a cellular phone or a computer.

3. The system of claim 1, wherein the indicium input mechanism comprises at least one of a scanner, a camera, an optical input device, a microphone, a keyboard or a keypad.

4. The system of claim 3, wherein at least one of the scanner, the camera, the optical input device, a microphone, a keyboard or a keypad is an integral part of the input device.

5. The system of claim 1, wherein the indicium comprises at least one of a bar code, a 2-dimensional bar code or an RFID tag.

6. The system of claim 1, wherein the indicium input mechanism comprises a webpage from the server, and wherein the input device includes a display area for displaying the webpage.

7. The system of claim 1, wherein the location identifier comprises a universal resource locator (URL).

8. The system of claim 7, wherein the input device is adapted to display a webpage corresponding to the URL.

9. The system of claim 1, wherein the indicium is on an advertisement or a product.

10. The system of claim 1, wherein the indicium input mechanism comprises a client software adapted to receive the indicium data and to generate the indicium lookup request using the indicium data.

11. A method of accessing information corresponding to an indicium, the method comprising:
reading the indicium using an input device to obtain indicium data;
generating a lookup request using the indicium data;
sending the lookup request to a server;
receiving a location identifier for information corresponding to the indicium, from the server;
accessing the information corresponding to the indicium, using the location identifier; and
displaying the accessed information on the input device.

12. The method of claim 11, wherein the indicium comprises a one or two dimensional bar code, and wherein said reading the indicium comprises scanning or photographing the one or two dimensional bar code.

13. The method of claim 11, wherein the indicium comprises an RFID tag, and wherein said reading the indicium comprises scanning the RFID tag.

14. The method of claim 11, wherein the location identifier comprises a universal resource locator (URL) of a webpage.

15. The method of claim 14, wherein said displaying the accessed information comprises displaying the webpage corresponding to the URL.

16. An indicium reading device comprising:
a scanning device adapted to input indicium data corresponding to an indicium;
a display device adapted to display information retrieved from a location associated with the indicium;
a communications device adapted to request the information using the indicium data; and
a processor adapted to execute a local application to generate a request to a server using the indicium data and to retrieve the information from the location associated with the indicium, for display on the display device.

17. The indicium reading device of claim 16, wherein the indicium comprises a one or two dimensional bar code, and the scanning device comprises a bar code reader or a camera.

18. The indicium reading device of claim 16, wherein the indicium comprises an RFID tag, and the scanning device comprises an RFID scanner.

19. The indicium reading device of claim 16, wherein the scanning device is an integral part of the indicium reading device.

20. The indicium reading device of claim 16, further comprising an audio input device for receiving voice data, and voice data processing software for obtaining the indicium data from the voice data.
